(19) United States
(12) Patent Application Publication
(10) Pub. No.: US 2024/0185616 A1
(43) Pub. Date: Jun. 6, 2024

(54) SYSTEM AND METHOD FOR VERIFYING ROAD NARROWS SIGNS

(71) Applicant: HERE Global B.V., Eindhoven (NL)

(72) Inventors: Leon STENNETH, Chicago, IL (US); Bruce BERNHARDT, Wauconda, IL (US); Advait RAUT, Virar West (IN); Jingwei XU, Buffalo Grove, IL (US); Alex AVERBUCH, Buffalo Grove, IL (US); Yuxin GUAN, Chicago, IL (US)

(21) Appl. No.: 18/075,951

(22) Filed: Dec. 6, 2022

(51) Int. Cl. G06V 20/58; G06V 20/56

(52) U.S. Cl. CPC G06V 20/582; G06V 20/588

(57) ABSTRACT

The disclosure provides a system, a method, and a computer program product for validating a road sign. The method comprises receiving at least one road sign observation associated with a location wherein the road sign observation comprises at least a road sign type. The method may include obtaining sensor data associated with the at least one road sign observation, based on at least the road sign type. The method may include calculating a number of lanes based on the sensor data. The method further includes, validating the road sign based on the number of lanes, wherein the road sign is validated as a correct road sign when the number of lanes is less than the number of lanes obtained from map data associated with the location.

### TECHNOLOGICAL FIELD

The present disclosure generally relates to routing and navigation applications, and more particularly relates to systems and methods for verifying road narrows signs in real time.

### BACKGROUND

Various navigation applications are available to aid a user during navigation, for example by providing directions for driving, walking, or other modes of travel. Often, a route traversed or to be traversed by a user encompasses a road works or road a construction site. Road narrows sign may indicate road construction. For example, road narrows signs inform the traveler if the road ahead is narrowed to the left, right, or both ways. The problem is that if road narrows signs are not handled correctly in a system where road works is learned from sensor data, they are a source of high false positives. For example, road narrows signs may exist outside of road works zone where number of lanes on a road is naturally reduced. In another example, road works sign, may be a left-over sign after road construction clean-up and hence does not affect traffic.

Therefore, there is a need for improved systems and methods for verifying road narrows signs accurately and dynamically in real time.

### BRIEF SUMMARY

Accordingly, in order to provide accurate, safe, and reliable navigation applications, it is important to update map data to reflect real time changes in route conditions, like placement of signs on the route. Further, safer, and user-oriented navigation services can be provided to the end users. To this end, the data utilized for providing the navigation application, such as navigation assistance should consider accurate and up-to-date navigation instructions for passage of a vehicle through various regions and routes. Especially, in the context of navigation assistance for autonomous vehicles and semi-autonomous vehicles, to avoid inaccurate navigation, it is important that the assistance provided is real-time, up-to-date, safe, and accurate. There is a need of a system that may validate a road sign and update map data based on the real time observations. Example embodiments of the present disclosure provide a system, a method, and a computer program product for validating a road sign in order to overcome the challenges discussed above, to provide the solutions envisaged as discussed above.

A system, a method and a computer programmable product are provided for implementing a process of validating a road sign.

Some example embodiments disclosed herein provide a method for validating a road sign. The method comprises receiving at least one road sign observation associated with a location wherein the road sign observation comprises at least a road sign type. The method may include obtaining sensor data associated with the at least one road sign observation, based on at least the road sign type. The method may further include calculating a first number of lanes based on the sensor data. The method may further include validating the road sign based on the first number of lanes, wherein the road sign is validated as a correct road sign when the first number of lanes is less than the number of lanes obtained from map data associated with the location.

According to some example embodiments, the method further comprises the step of validating that the road sign is a false positive road sign when the calculated number of lanes is equal to the number of lanes obtained from the map data associated with the location.

According to some example embodiments, sensor data further comprises road boundary data, wherein the road boundary data comprises one or more of a position offset data, a lateral offset data, longitudinal offset data, and a timestamp data.

According to some example embodiments, the road sign type comprises at least a road narrows sign wherein the road narrows sign comprises at least one of: a road narrows right, a road narrows left or a road narrows right and left.

According to some example embodiments, the road narrows sign further comprises at least one of a road works sign.

According to some example embodiments, the road sign observation further comprises at least a background color, the background color further comprising at least one of a color indicating a temporary change in the first number of lanes.

According to some example embodiments, obtaining sensor data further comprises obtaining the sensor data after a configurable distance.

According to some example embodiments, the method further comprises the step of obtaining probe data associated with the at least one road sign observation, based on the at least the road sign type. The method may include calculating a second number of lanes based on the probe data. The method may further include validating the road sign based on the second number of lanes, wherein the road sign is validated as the correct road sign when the second number of lanes is less than the number of lanes obtained from the map data associated with the location.

According to some example embodiments, validating that the road sign is the correct road sign is based on the first number of lanes and second number of lanes.

In one aspect, a system for validating a road sign is disclosed. The system comprises a memory configured to store computer-executable instructions; and at least one processor configured to execute the computer-executable instructions to receive at least one road sign observation associated with a location wherein the road sign observation comprising at least a road sign type. The at least one processor is further configured to obtain sensor data associated with the at least one road sign, based on the at least one road sign type. The at least one processor is further configured to calculate a first number of lanes based on the sensor data. Also, the at least one processor is configured to validate the road sign based on the first number of lanes, wherein the road sign is validated as a correct road sign when the first number of lanes is less than the number of lanes obtained from map data associated with the location.

In yet another aspect, a computer program product comprising a non-transitory computer readable medium having stored thereon computer executable instructions which when executed by at least one processor, cause the processor to carry out operations for validating a road sign, the operations comprising receiving at least one road sign observation associated with a location wherein the road sign observation comprises at least a road sign type. The operations further comprise obtaining sensor data associated with the at least one road sign observation, based on at least the road sign type. The operations further comprise calculating a first number of lanes based on the sensor data. The operations further comprise validating the road sign based on the first number of lanes, wherein the road sign is validated as a correct road sign when the first number of lanes is less than the number of lanes obtained from map data associated with the location.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a schematic diagram of a network environment of a system for validating a road sign, in accordance with an example embodiment;

FIG. 2A illustrates a block diagram of the system for validating a road sign, in accordance with an example embodiment;

FIG. 2A-1 illustrates working of a location detection module, in accordance with an example embodiment;

FIG. 2A-2 illustrates working of a location detection module, in accordance with an example embodiment;

FIG. 2B illustrates an exemplary map database record storing data, in accordance with one or more example embodiments;

FIG. 2C illustrates another exemplary map database record storing data, in accordance with one or more example embodiments;

FIG. 2D illustrates another exemplary map database storing data, in accordance with one or more example embodiments;

FIG. 3 illustrates a block diagram of the system of FIG. 2A, in accordance with an example embodiment;

FIG. 4 illustrates a flow diagram of the system for validating a road sign, in accordance with an example embodiment.

FIG. 5 illustrates a flow chart of the system for validating road sign, in accordance with an example embodiment.

FIGS. 6A and 6B illustrates working example of the system, in accordance with an example embodiment.

FIG. 7 illustrates a format of road boundary recognition message structure processed by location detection module to calculate number of lanes, in accordance with an example embodiment.

FIG. 8 illustrates a flow diagram of a method for validating road sign using sensor data, in accordance with an example embodiment.

FIG. 9 illustrates a flow diagram of a method for validating road sign using probe data, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “route” may be used to refer to a path from a source location to a destination location on any link.

The term “autonomous vehicle” may refer to any vehicle having autonomous driving capabilities at least in some conditions. The autonomous vehicle may also be known as a driverless car, robot car, self-driving car, or autonomous car. For example, the vehicle may have zero passengers or passengers that do not manually drive the vehicle, but the vehicle drives and maneuvers automatically. There can also be semi-autonomous vehicles.

The term “road works or roadwork zones” may refer to a section of a road, an entire road, or a sequence of roads that are occupied for the purpose of, for example, road surface repairs, work on power lines, water works and road accidents, among others. In certain scenarios, the roadwork may disable an entire lane temporarily. As a result, travelers may experience delays and increased travel time on a road as compared to a road without roadwork. In some scenarios, drivers near a roadwork zone may have to drive skillfully and slowly. In certain other scenarios, the vehicles on a lane affected by the roadwork may be directed by road administration to take a detour via longer possible route. Consequently, the drivers and passengers may experience wastage of time and energy.

### End of Definitions

Embodiments of the present disclosure may provide a system, a method, and a computer program product for verifying a road sign. The road sign may be road narrows sign representing road works or natural reduction of lanes. The road narrows sign of road works is presumed to affect traffic. The road narrows signs, if not handled correctly, in a system where road works is learned from sensor data, are a source of high false positives. It may in practical scenarios cause unnecessary transition from autonomous mode to manual mode, in autonomous or semi-autonomous vehicles. Overall, it may be bothersome and unnecessary for users. To that end, it would be advantageous to provide methods and systems that facilitate updated navigation instructions related to routing of traffic in the presence of such signs.

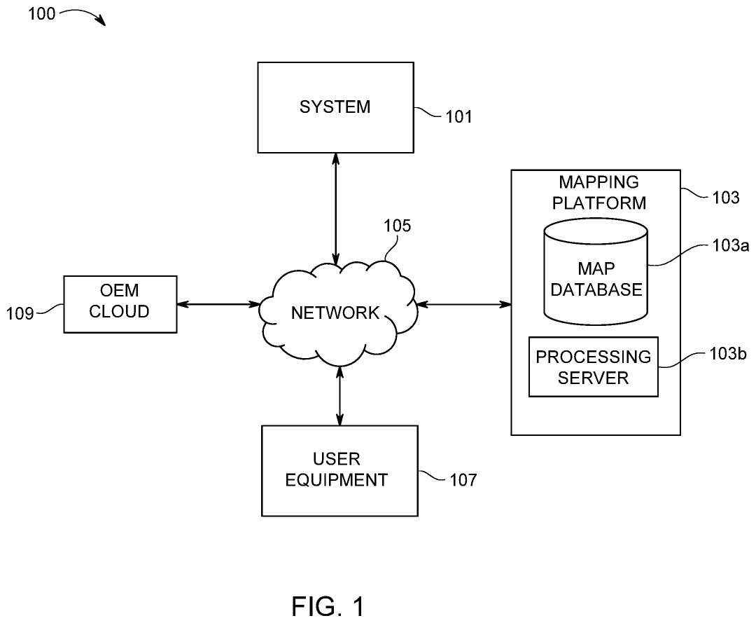

To that end, it would be advantageous to provide methods and systems that facilitate validating a road sign in such an improved manner are described with reference to FIG. 1 to FIG. 9 as detailed below.

FIG. 1 illustrates a schematic diagram of a network environment 100 of a system 101 for validating a road sign, in accordance with an example embodiment. The system 101 may be communicatively coupled to a mapping platform 103, a user equipment 107 and an OEM (Original Equipment Manufacturer) cloud 109, via a network 105. The components described in the network environment 100 may be further broken down into more than one component such as one or more sensors or application in user equipment and/or combined together in any suitable arrangement. Further, it is possible that one or more components may be rearranged, changed, added, and/or removed without deviating from the scope of the present disclosure.

In an example embodiment, the system 101 may be embodied in one or more of several ways as per the required implementation. For example, the system 101 may be embodied as a cloud-based service, a cloud-based application, a remote server-based service, a remote server-based application, a virtual computing system, a remote server platform or a cloud-based platform. As such, the system 101 may be configured to operate outside the user equipment 107. However, in some example embodiments, the system 101 may be embodied within the user equipment 107, for example as a part of an in-vehicle navigation system, a navigation app in a mobile device and the like. In each of such embodiments, the system 101 may be communicatively coupled to the components shown in FIG. 1 to carry out the desired operations and wherever required modifications may be possible within the scope of the present disclosure. The system 101 may be implemented in a vehicle, where the vehicle may be an autonomous vehicle, a semi-autonomous vehicle, or a manually driven vehicle. In an embodiment, the system 101 may be deployed in a consumer vehicle to generate navigation information in a region. Further, in one embodiment, the system 101 may be a standalone unit configured to generate navigation information in the region for the vehicle. Alternatively, the system 101 may be coupled with an external device such as the autonomous vehicle. In some embodiments, the system 101 may be a processing server 103b of the mapping platform 103 and therefore may be co-located with or within the mapping platform 103. In some other embodiments, the system 101 may be an OEM (Original Equipment Manufacturer) cloud, such as the OEM cloud 109. The OEM cloud 109 may be configured to anonymize any data received from the system 101, such as the vehicle, before using the data for further processing, such as before sending the data to the mapping platform 103. In some embodiments, anonymization of data may be done by the mapping platform 103.

The mapping platform 103 may comprise a map database 103a for storing map data and a processing server 103b. The map database 103a may store node data, road segment data, link data, point of interest (POI) data, link identification information, heading value records, data about various geographic zones, regions, pedestrian data for different regions, heatmaps or the like. Also, the map database 103a further includes speed limit data of different lanes, cartographic data, routing data, and/or maneuvering data. Additionally, the map database 103a may be updated dynamically to cumulate real time traffic data. The real time traffic data may be collected by analyzing the location transmitted to the mapping platform 103 by a large number of road users through the respective user devices of the road users. In one example, by calculating the speed of the road users along a length of road, the mapping platform 103 may generate a live traffic map, which is stored in the map database 103a in the form of real time traffic conditions. In an embodiment, the map database 103a may store data of different zones in a region. In one embodiment, the map database 103a may further store historical traffic data that includes travel times, average speeds and probe counts on each road or area at any given time of the day and any day of the year. In an embodiment, the map database 103a may store the probe data over a period of time for a vehicle to be at a link or road at a specific time. The probe data may be collected by one or more devices in the vehicle such as one or more sensors or image capturing devices or mobile devices. In an embodiment, the probe data may also be captured from connected-car sensors, smartphones, personal navigation devices, fixed road sensors, smart-enabled commercial vehicles, and expert monitors observing accidents and construction. In an embodiment, the map data in the map database 103a may be in the form of map tiles. Each map tile may denote a map tile area comprising plurality of road segments or links in it. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network used by vehicles such as cars, trucks, buses, motorcycles, and/or other entities. Optionally, the map database 103a may contain path segment and node data records, such as shape points or other data that may represent pedestrian paths, links, or areas in addition to or instead of the vehicle road record data, for example. The road/link and nodes can be associated with attributes, such as geographic coordinates, street names, address ranges, speed limits, turn restrictions at intersections, and other navigation related attributes. The map database 103a may also store data about the POIs and their respective locations in the POI records. The map database 103a may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 103a may include event data (e.g., traffic incidents, construction activities, scheduled events, unscheduled events, accidents, diversions etc.) associated with the POI data records or other records of the map database 103a associated with the mapping platform 103. Optionally, the map database 103a may contain path segment and node data records or other data that may represent pedestrian paths or areas in addition to or instead of the autonomous vehicle road record data.

In some embodiments, the map database 103a may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, navigation instruction generation and other functions, by a navigation device, such as by the user equipment 107. The navigation-related functions may correspond to vehicle navigation, pedestrian navigation, navigation instruction suppression, navigation instruction generation based on user preference data or other types of navigation. The compilation to produce the end user databases may be performed by a party or entity separate from the map developer. For example, a customer of the map developer, such as a navigation device developer or other end user device developer, a navigation app service provider and the like may perform compilation on a received map database in a delivery format to produce one or more compiled navigation databases.

As mentioned above, the map database 103a may be a master geographic database, but in alternate embodiments, the map database 103a may be embodied as a client-side map database and may represent a compiled navigation database that may be used in or with end user equipment such as the user equipment 107 to provide navigation and/or map-related functions. For example, the map database 103a may be used with the user equipment 107 to provide an end user with navigation features. In such a case, the map database 103a may be downloaded or stored locally (cached) on the user equipment 107.

The processing server 103b may comprise processing means, and communication means. For example, the processing means may comprise one or more processors configured to process requests received from the user equipment 107. The processing means may fetch map data from the map database 103a and transmit the same to the user equipment 107 via OEM cloud 109 in a format suitable for use by the user equipment 107. In one or more example embodiments, the mapping platform 103 may periodically communicate with the user equipment 107 via the processing server 103b to update a local cache of the map data stored on the user equipment 107. Accordingly, in some example embodiments, the map data may also be stored on the user equipment 107 and may be updated based on periodic communication with the mapping platform 103.

In some example embodiments, the user equipment 107 may be any user accessible device such as a mobile phone, a smartphone, a portable computer, and the like, as a part of another portable/mobile object such as a vehicle. The user equipment 107 may comprise a processor, a memory, and a communication interface. The processor, the memory and the communication interface may be communicatively coupled to each other. In some example embodiments, the user equipment 107 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example embodiments, the user equipment 107 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment 107. Additional, different, or fewer components may be provided. In one embodiment, the user equipment 107 may be directly coupled to the system 101 via the network 105. For example, the user equipment 107 may be a dedicated vehicle (or a part thereof) for gathering data for development of the map data in the database 103a. In some example embodiments, at least one user equipment such as the user equipment 107 may be coupled to the system 101 via the OEM cloud 109 and the network 105. For example, the user equipment 107 may be a consumer vehicle (or a part thereof) and may be a beneficiary of the services provided by the system 101. In some example embodiments, the user equipment 107 may serve the dual purpose of a data gatherer and a beneficiary device. The user equipment 107 may be configured to capture sensor data associated with a road which the user equipment 107 may be traversing. The sensor data may for example be image data of road objects, road signs, or the surroundings. The sensor data may refer to sensor data collected from a sensor unit in the user equipment 107. In accordance with an embodiment, the sensor data may refer to the data captured by the vehicle using sensors. The user equipment 107, may be communicatively coupled to the system 101, the mapping platform 103 and the OEM cloud 109 over the network 105.

The network 105 may be wired, wireless, or any combination of wired and wireless communication networks, such as cellular, Wi-Fi, internet, local area networks, or the like. In one embodiment, the network 105 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an embodiment the network 105 is coupled directly or indirectly to the user equipment 107 via the OEM cloud 109. In an example embodiment, the system may be integrated in the user equipment 107. In an example, the mapping platform 103 may be integrated into a single platform to provide a suite of mapping and navigation related applications for OEM devices, such as the user devices and the system 101. The system 101 may be configured to communicate with the mapping platform 103 over the network 105. Thus, the mapping platform 103 may enable provision of cloud-based services for the system 101, such as, updating data about road signs in the OEM cloud 109 in batches or in real-time.

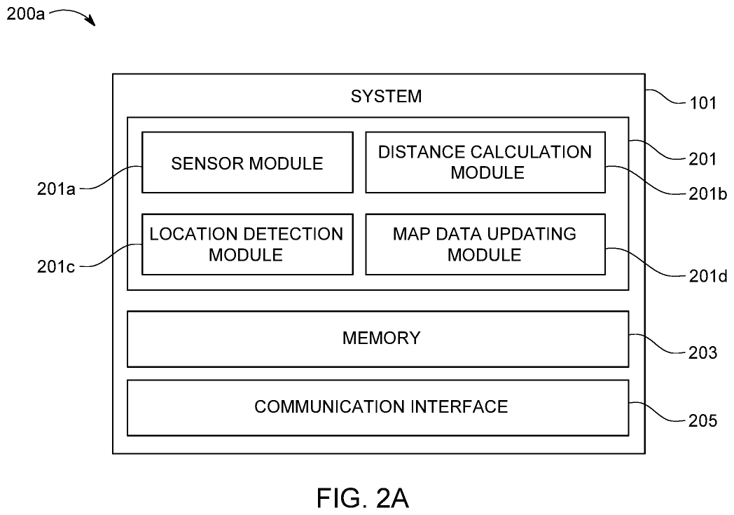

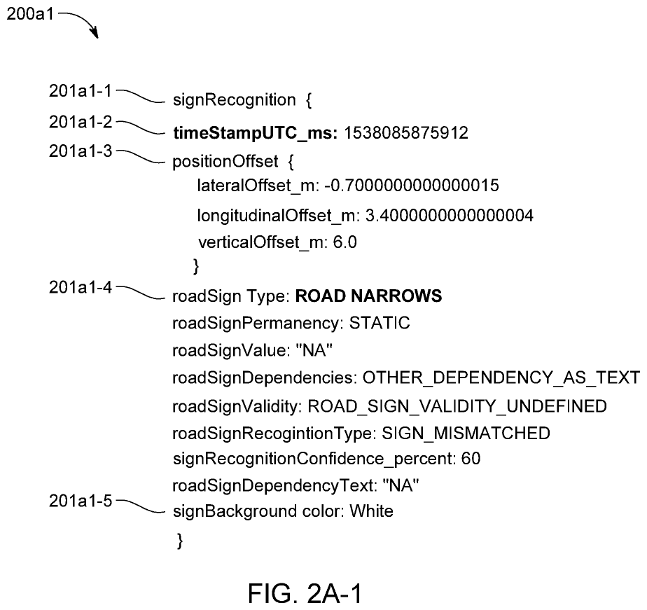

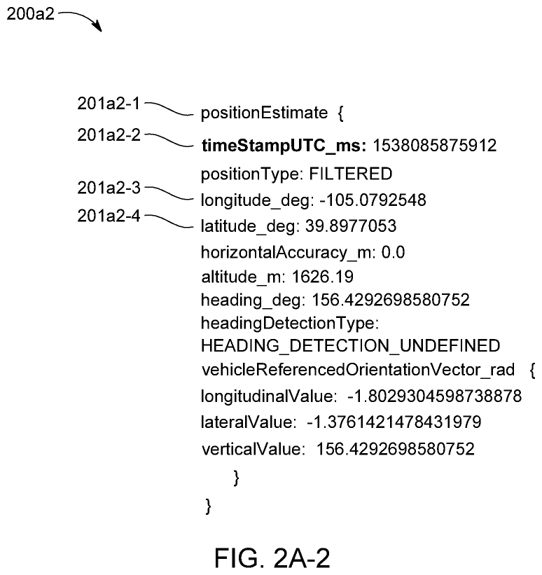

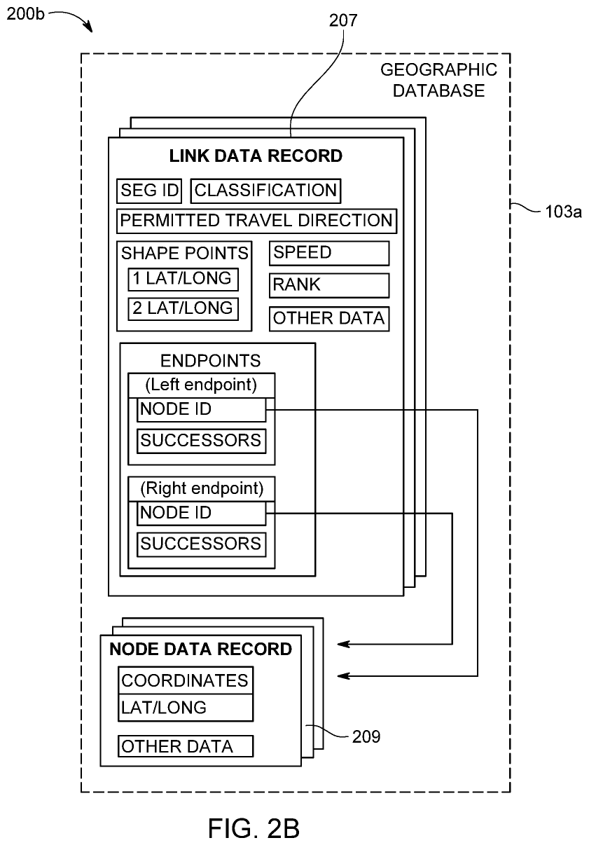

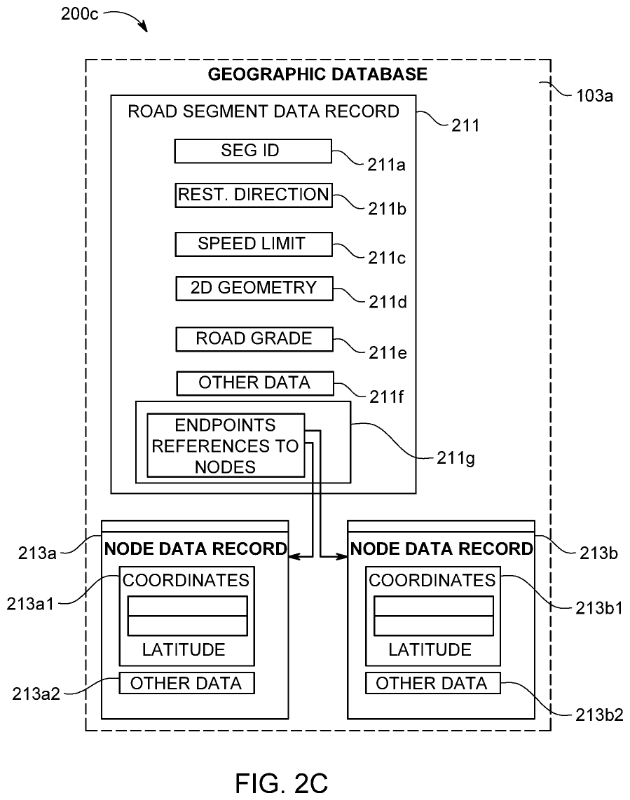

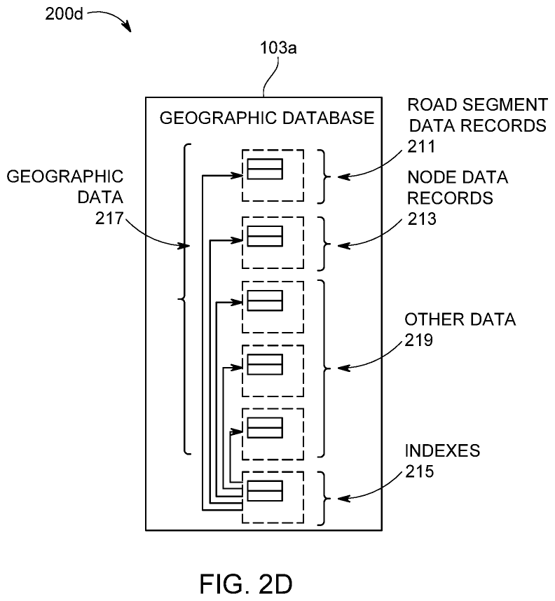

FIG. 2A illustrates a block diagram 200a of the system 101 for validating road signs, in accordance with an example embodiment. The system 101 may include at least one processor 201 (hereinafter, also referred to as “processor 201”), at least one memory 203 (hereinafter, also referred to as “memory 203”), and at least one communication interface 205 (hereinafter, also referred to as “communication interface 205”). The processor 201 may include a sensor module 201a, a distance calculation module 201b, a location detection module 201c and a map data updating module 201d. The processor 201 may retrieve computer program code instructions that may be stored in the memory 203 for execution of the computer program code instructions.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

In some embodiments, the processor 201 may be configured to provide Internet-of-Things (IoT) related capabilities to users of the system 101. In some embodiments, the users may be or correspond to an autonomous or a semi-autonomous vehicle. The IoT related capabilities may in turn be used to provide smart navigation solutions by providing real time updates to the users to take pro-active decision on turn-maneuvers, lane changes and the like, big data analysis, traffic redirection, and sensor-based data collection by using the cloud-based mapping system for providing navigation recommendation services to the users. The system 101 may be accessed using the communication interface 205. The communication interface 205 may provide an interface for accessing various features and data stored in the system 101. Further, from the user equipment 107, at least one location on map is received.

Additionally, or alternatively, the processor 201 may include one or more processors capable of processing large volumes of workloads and operations to provide support for big data analysis. In an example embodiment, the processor 201 may be in communication with the memory 203 via a bus for passing information among components coupled to the system 101.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to conduct various functions in accordance with an example embodiment of the present invention. For example, the memory 203 may be configured to buffer input data for processing by the processor 201.

As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The sensor module 201a may include acoustic sensors such as a microphone array, position sensors such as a GPS sensor, a gyroscope, a LIDAR sensor, a proximity sensor, motion sensors such as accelerometer, an image sensor such as a camera and the like. The sensor module 201a may be configured to receive sensor data from the user equipment 107. The sensor data may be associated with a road object. The road object includes various types of objects that are encountered on a route of travel of the user equipment. For example, when the user equipment 107 is a vehicle, the road object may be a road sign, such as a construction related sign, a road narrows sign, a speed limit sign, a road works detection sign, a traffic cone, a guide rail, and the like. In one embodiment, the camera associated with the vehicle captures the road sign in the form of a road observation. For example, the road observation may be in the form of a Sensor Data Ingestion Interface (SDII) message format (explained later). Once the sensor data in the form of the road observation is received by the sensor module 201a, the sensor data is processed to extract information related to a first location at which the road observation sight was made.

To that end, the location detection module 201c is configured to process the sensor data messages received by the sensor module 201a. The location detection module 201c determines a timestamp value included in the sensor data of the road observation sight, which is in the form of a first message. The first message may be for example a signRecognition message. This timestamp value is matched with a timestamp value of a second message received by the sensor module 201a. This second message is for example a positionEstimate message. Based on this timestamp matching, the first location is determined as the location information included in the second message. The timestamp matching is further explained in detail in FIG. 2A-1 and FIG. 2A-2.

Further, the location detection module 201c is configured to by apply the positionOffsets in the signRecognition message to the first location identified from the previous step, to identify the second location. This second location is the location of the road object, or the road narrows sign, which is determined by using all of the previous information like the timestamp used for matching, the first location and the data included in the second message of the sensor data.

Further, the distance calculation module 201b, in the processor 201, may be configured to determine a length of a perpendicular bisector from the second location of the road object to the center of a link. The link in this embodiment is a map matched link associated with the second location.

Based on this calculated distance, the map data may be updated by the map data updating module 201d. The map data updating module 201d may include a remote server, a cloud-based server, and a map database. The cloud-based server may be an OEM (Original Equipment Manufacturer) cloud, such as the OEM cloud 109. The updated map data may then be used for further communication in navigation applications involving the system 101, by suitable access mechanisms provided by the communication interface 205 module.

The communication interface 205 may comprise input interface and output interface for supporting communications to and from the user equipment 107 or any other component with which the system 101 may communicate. The communication interface 205 may be any means such as a device or circuitry embodied in either hardware or a combination of hardware and software that is configured to receive and/or transmit data to/from a communications device in communication with the user equipment 107. In this regard, the communication interface 205 may include, for example, an antenna (or multiple antennae) and supporting hardware and/or software for enabling communications with a wireless communication network. Additionally, or alternatively, the communication interface 205 may include the circuitry for interacting with the antenna(s) to cause transmission of signals via the antenna(s) or to handle receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB) or other mechanisms for enabling the system 101 to carry out information exchange functions in many different forms of communication environments. The communication interface enables exchange of information and instructions for updating map data stored in the map database 103a.

FIG. 2A-1 illustrates working of a location detection module, in accordance with an example embodiment. The location detection module 201c determines a timestamp value 201a1-2 included in the sensor data of the road sign observation, which is in the form of a first message. The first message may be for example a signRecognition message 201a1-1. The location detection module 201c extracts the timestamp 201a1-2 of the signRecognition message 201a1-1. This timestamp value 201a1-2 is matched with a timestamp value 201a2-2 of a second message 200a2-1 shown in FIG. 2A-2, received by the sensor module 201a. Based on this timestamp matching, the first location is a longitude_deg 201a2-3 and a latitude_deg 201a2-4 in the matching positonEstimate message which is depicted as the second message 201a2-1. The signRecognition message 201a1-1 comprises data about road sign type 201a1-4, and road sign background color 201a1-5.

FIG. 2A-2 illustrates a format 200a2 of the second message 200a2-1 processed by the location detection module 201c, to determine the second location, in accordance with an example embodiment. Further, the location detection module 201c is configured to apply positionOffsets 201a1-3, in the signRecognition message 201a1-1 to the first location identified from the previous step, to identify the second location. The positionoffsets 201a1-3 includes a lateral offset, a longitudinal offset, and a vertical offset. The timestamp value 201a1-2 is matched with the timestamp value 201a2-2 of the second message 200a2-1 received by the sensor module 201a. This second location is the location of the road sign or road narrows sign, which is determined by using all of the previous information like the timestamp used for matching, the first location and the data included in the second message of the sensor data.

The second location is then further used for determining whether the road sign observation is a true sign observation or a false positive, and further the map database 103a and the data stored in it is updated based on the determination. The true sign observation is the road narrows sign which depict the number of lanes is reduced to control road traffic.

FIG. 2B shows format of the map data 200b stored in the map database 103a according to one or more example embodiments. FIG. 2B shows a link data record 207 that may be used to store data about one or more of the feature lines. This link data record 207 has information (such as “attributes”, “fields”, etc.) associated with it that allows identification of the nodes associated with the link and/or the geographic positions (e.g., the latitude and longitude coordinates and/or altitude or elevation) of the two nodes. In addition, the link data record 207 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record 207 that represents another-than-straight road segment may include shape point data. A shape point is a location along a link between its endpoints. To represent the shape of other-than-straight roads, the mapping platform 103 and its associated map database developer selects one or more shape points along the other-than-straight road portion. Shape point data included in the link data record 207 indicate the position, (e.g., latitude, longitude, and optionally, altitude or elevation) of the selected shape points along the represented link.

Additionally, in the compiled geographic database, such as a copy of the map database 103a, there may also be a node data record 209 for each node. The node data record 209 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

FIG. 2C shows another format of the map data 200c stored in the map database 103a according to one or more example embodiments. In the FIG. 2C, the map data 200c is stored by specifying a road segment data record 211. The road segment data record 211 is configured to represent data that represents a road network. In FIG. 2C, the map database 103a contains at least one road segment data record 211 (also referred to as “entity” or “entry”) for each road segment in a geographic region.

The map database 103a that represents the geographic region of FIG. 2A also includes a database record 213 (a node data record 213a and a node data record 213b) (or “entity” or “entry”) for each node associated with the at least one road segment shown by the road segment data record 211. (The terms “nodes” and “segments” represent only one terminology for describing these physical geographic features and other terminology for describing these features is intended to be encompassed within the scope of these concepts). Each of the node data records 213a and 213b may have associated information (such as “attributes”, “fields”, etc.) that allows identification of the road segment(s) that connect to it and/or its geographic position (e.g., its latitude and longitude coordinates).

FIG. 2C shows some of the components of the road segment data record 211 contained in the map database 103a. The road segment data record 211 includes a segment ID 211a by which the data record can be identified in the map database 103a. Each road segment data record 211 has associated with it information (such as “attributes”, “fields”, etc.) that describes features of the represented road segment. The road segment data record 211 may include data 211b that indicate the restrictions, if any, on the direction of vehicular travel permitted on the represented road segment. The road segment data record 211 includes data 211c that indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 211 may also include data 211d indicating the two-dimensional (“2D”) geometry or shape of the road segment. If a road segment is straight, its shape can be represented by identifying its endpoints or nodes. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 211 also includes road grade data 211e that indicate the grade or slope of the road segment. In one embodiment, the road grade data 211e include road grade change points and a corresponding percentage of grade change. Additionally, the road grade data 211e may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 211e includes the road grade change points and an actual road grade value for the portion of the road segment after the road grade change point until the next road grade change point or end node. In a further embodiment, the road grade data 211e includes elevation data at the road grade change points and nodes. In an alternative embodiment, the road grade data 211e is an elevation model which may be used to determine the slope of the road segment.

The road segment data record 211 also includes data 211g providing the geographic coordinates (e.g., the latitude and longitude) of the end points of the represented road segment. In one embodiment, the data 211g are references to the node data records 211 that represent the nodes corresponding to the end points of the represented road segment.

The road segment data record 211 may also include or be associated with other data 211f that refer to various other attributes of the represented road segment. The various attributes associated with a road segment may be included in a single road segment record or may be included in more than one type of record which cross-reference each other. For example, the road segment data record 211 may include data identifying the name or names by which the represented road segment is known, the street address ranges along the represented road segment, and so on.

FIG. 2C also shows some of the components of the node data record 213 contained in the map database 103a. Each of the node data records 213 may have associated information (such as “attributes”, “fields”, etc.) that allows identification of the road segment(s) that connect to it and/or it's geographic position (e.g., its latitude and longitude coordinates). For the embodiment shown in FIG. 2C, the node data records 213a and 213b include the latitude and longitude coordinates 213a1 and 213b1 for their nodes. The node data records 213a and 213b may also include other data 213a2 and 213b2 that refer to various other attributes of the nodes.

Thus, the overall data stored in the map database 103a may be organized in the form of different layers for greater detail, clarity, and precision. Specifically, in the case of high-definition maps, the map data may be organized, stored, sorted, and accessed in the form of three or more layers. These layers may include road level layer, lane level layer and localization layer. The data stored in the map database 103a in the formats shown in FIGS. 2B and 2C may be combined in a suitable manner to provide these three or more layers of information. In some embodiments, there may be lesser or fewer number of layers of data also possible, without deviating from the scope of the present disclosure.

FIG. 2D illustrates a block diagram 200d of the map database 103a storing map data or geographic data 217 in the form of road segments/links, nodes, and one or more associated attributes as discussed above. Furthermore, attributes may refer to features or data layers associated with the link-node database, such as an HD lane data layer.

In addition, the map data 217 may also include other kinds of data 219. The other kinds of data 219 may represent other kinds of geographic features or anything else. The other kinds of data may include point of interest data. For example, the point of interest data may include point of interest records comprising a type (e.g., the type of point of interest, such as restaurant, ATM, etc.), location of the point of interest, a phone number, hours of operation, etc. The map database 103a also includes indexes 215. The indexes 215 may include various types of indexes that relate the different types of data to each other or that relate to other aspects of the data contained in the geographic database 103a.

The data stored in the map database 103a in the various formats discussed above may help in provide precise data for high-definition mapping applications, autonomous vehicle navigation and guidance, cruise control using ADAS, direction control using accurate vehicle maneuvering and other such services. In some embodiments, the system 101 accesses the map database 103a storing data in the form of various layers and formats depicted in FIGS. 2B-2D.

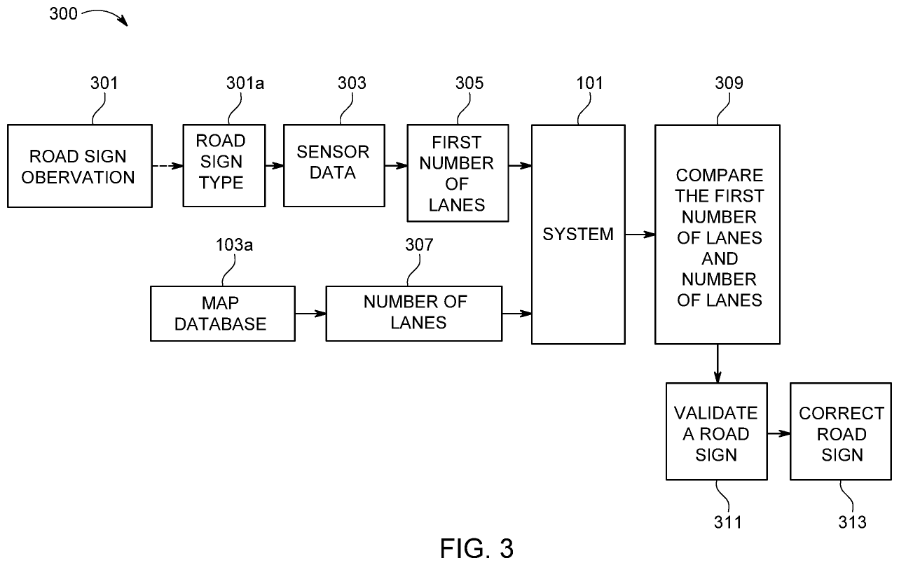

FIG. 3 is a block diagram of the system 101, in accordance with an example embodiment. The system 101 may be configured to receive at least one road sign observation 301 associated with a location. The road sign observation 301 comprises at least a road sign type 301a. The road sign type 301a may be a road narrows sign. Further, the road narrows sign may be a road narrows right, a road narrows left or a road narrows right and left sign. The system 101 may be further configured to obtain sensor data 303 associated with the at least one road sign observation 301, based on the at least one road sign type 301a. A first number of lanes 305 is calculated from the sensor data 303. The system 101 may be configured to receive a number of lanes 307 associated with the location from a map database 103a. The first number of lanes 305 may be compared with the number of lanes 309 to validate a road sign. The system 101 may be further configured to validate a road sign 311 as a correct road sign 313 when the first number of lanes 305 is less than the number of lanes 307 obtained from map database 103a. The correct road sign 313 may be a narrows road sign representing road works.

In accordance with an embodiment, the system may be configured to validate a road sign 309 as a false positive when the first number of lanes 305 is equal to the number of lanes 307 obtained from map database 103a.

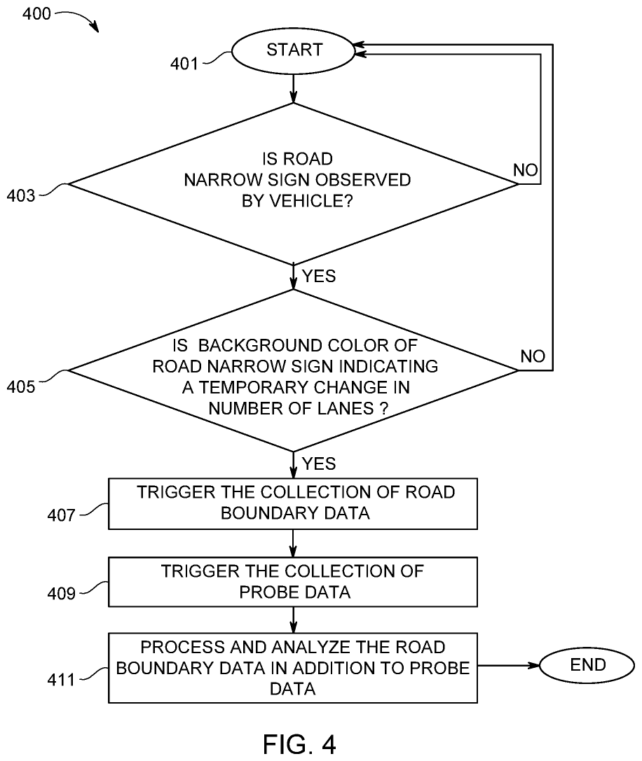

FIG. 4 illustrates a flow diagram 400 of different steps performed by the system 101 for validating a road sign, in accordance with an example embodiment. Starting at block 401, a road sign may be observed using one or more sensors of a vehicle. The one or more sensors may be a GPS sensor, a gyroscope, a LIDAR sensor, a radar sensor, a proximity sensor, motion sensors such as accelerometer, an image sensor such as a camera or like. In one embodiment, the image sensor of the vehicle captures the road sign in the form of the road observation and the GPS sensor may be configured to store a location at which the road sign is observed. The road sign observation comprises a sign type.

According to one example embodiment, the road sign may be a road narrows sign, a speed limit sign, a road works sign, and the like. The road narrows sign may be a road narrows right, a road narrows left or a road narrows right and left. At block 403, the system may be configured to determine if the sign type is the road narrows sign.

If the sign type is the road narrows sign, then at block 405, the system may be configured to determine if the background color of the road narrows sign indicating a temporary change in the number of lanes due to road works, for example, orange yellow or red. In another embodiment, the background color representing road works is country specific.

If the road narrows sign's background color indicating a temporary change in the number of lanes due to road works then at block 407, the system may be configured to collect road boundary data and at block 409 the system may be configured to collect probe data. The road boundary data may comprise one or more of a position offset data, a lateral offset data, a longitudinal offset data, a timestamp data, and a road boundary type data. The lateral offset is the vehicle position with respect to the lane centerline. The time stamp data may comprise a date and time at which road boundary data is collected. The road boundary data may also include the distance of the road edge from the vehicle's center point, number of lanes, etc. and is reported directly by vehicles.

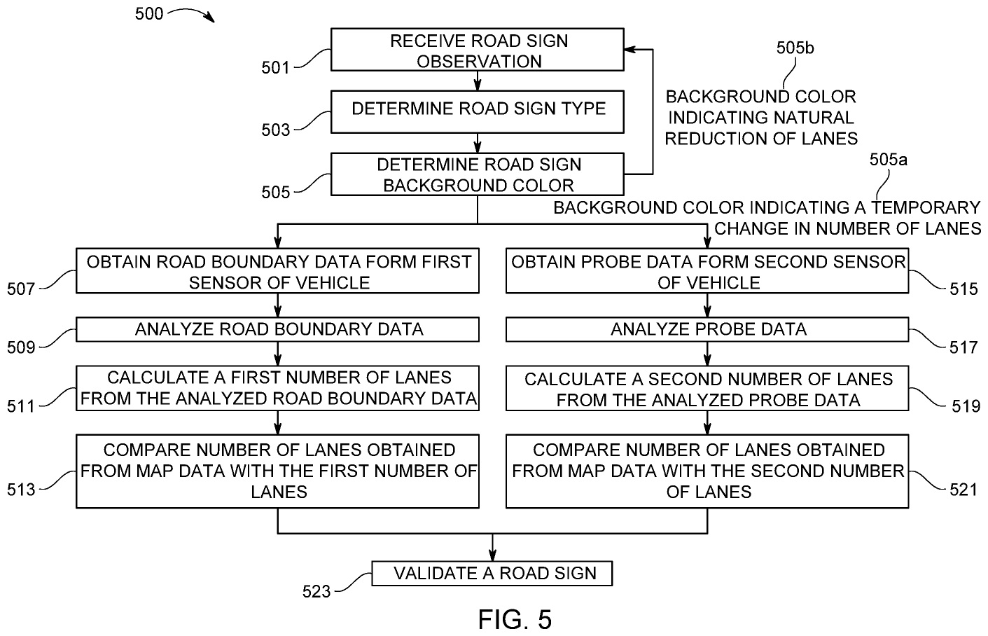

At step 411, the system may be configured to process and analyze the road boundary data and probe data. A further granular functionality compared to FIG. 4. of the system 101 is disclosed in FIG. 5.

FIG. 5 illustrates a flow diagram 500 of the system 101 for validating a road sign, in accordance with an example embodiment. At step 501, the system may be configured to receive a road sign observation associated with a location. The road sign observation comprises a road sign type

At step 503, the system may be configured to determine a road sign type. The road sign type may be a road narrows sign. The road narrows sign, for example, may be narrows right, a road narrows left, and a road narrows right and left sign. The road narrows sign may be a road works sign.

At step 505, the system may be configured to determine a road sign's background color. In one embodiment, the road sign's background color, may be a color indicating a temporary change in the number of lanes due to road works, for example, orange yellow or red. In another embodiment, the background color representing road works is country specific. In other embodiment, the road sign's background color may be the color representing natural reduction of lane, for example, white.

If the road sign's background color representing natural reduction of lane 505b, for example white, then the system may proceed to step 501. If the background color indicating a temporary change in the number of lanes 505a, due to road works, for example, orange, yellow or red, then the system may proceed to steps 507 and 515. In some embodiments the steps 507 and 515 may be executed parallelly or sequentially in any order. The system may be configured to obtain road boundary data and probe data at steps 507, and 515 respectively. The road boundary data comprises one or more of a position offset data, a lateral offset data, longitudinal offset data, and a timestamp data.

At step 509, the system may be configured to analyze road boundary data and at step 517, the system may be configured to analyze probe data.

Further, at step 511, the system may be configured to calculate a first number of lanes from the analyzed road boundary data. At step 519, the system may be configured to calculate a second number of lanes from the analyzed probe data.

Further, at step 513, the system may be configured to compare the number of lanes obtained from the map data with the first number of lanes, and at step 521, the system may be configured to compare the number of lanes obtained from the map data with the second number of lanes.

If the first number of lanes is less than number of lanes obtained from the map and the second number of lanes is less than the number of lanes obtained from the map then at step 523, the system may be configured to validate the road sign as the correct road sign.

In another embodiment, if the first number of lanes is less than the number of lanes obtained from the map or if the second number of lanes is less than the number of lanes obtained from the map then the system may be configured to validate the road sign as the correct road sign.

The road narrows sign is a false positive when the first number of lanes is equal to the number of lanes obtained from the map and the second number of lanes is equal to the number of lanes obtained from the map data. Further, the first number of lanes and second number of lanes are used to compute and increase road works confidence since they are verified as intended to control traffic flow.

According to one exemplary embodiment, the system may be configured to update map data when the road sign is the correct road sign.

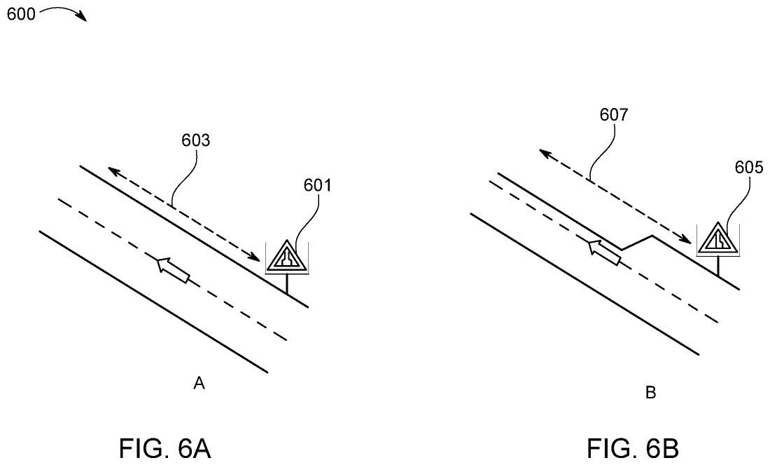

FIGS. 6A and 6B illustrate working example 600 of the system, in accordance with an example embodiment. In FIG. 6A, the system may receive road sign observation 601 associated with the location. The road sign observation 603 may comprises road narrows sign for example, may be road narrows right, road narrows left and road narrows right and left. The road narrows sign may further comprise a background color indicating a temporary change in the number of lanes due to road works, for example orange, yellow or red. The system may be configured to obtain road boundary data and probe data after a configurable distance 603. The configurable distance 603 may be, country specific, for example, two kilometer after the road narrows sign is determined.

FIG. 6A shows that the number of lanes is not reduced based on the road boundary data and probe data. The road narrows sign is not intended to control road works traffic.

In FIG. 6B, the system may receive road sign observation 605 associated with the location. The road sign observation 605 may comprise road narrows sign such as road narrows right, road narrows left. The road narrows sign may further comprise a background color indicating a temporary change in the number of lanes, may be yellow, orange, or red due to road works. The system may be configured to obtain road boundary data and probe data after a configurable distance 607. The configurable distance 603 may be, country specific, for example, two kilometer after the background color indicating a temporary change in the number of lanes, is determined by the system.

FIG. 6B may show that the number of lanes is reduced based on the road boundary data and probe data. The road narrows sign may be a road works sign intended to control road works traffic.

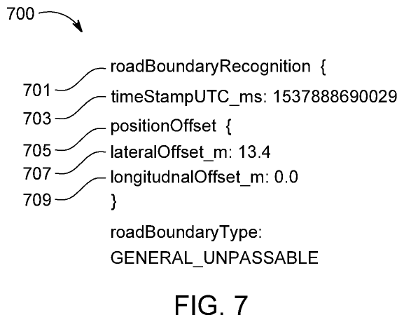

FIG. 7 illustrates a format 700 of road boundary recognition message 701 processed by the location detection module 201c to calculate number of lanes, in accordance with an example embodiment. The location detection module 201c extracts the timestamp 703 of the road boundary recognition message 701. Further, the location detection module 201c extracts position offset 705. The position offset 705 includes a lateral offset 707, and a longitudinal offset 709. The lateral offset 707 is double data type with unit in meters, range (−∞, ∞) and resolution <=1/100 meters. The lateral offset value is used to describe a distance to the side of the vehicle from a vehicle's reference point. The vehicle's reference point is the absolute position of the vehicle. A positive value is to the right of the vehicle in driving direction and a negative value is to the left. The roadBoundary type is unpassable in FIG. 7, meaning that it may be a physical divider made from concrete or iron.

According to one embodiment, the road boundary data includes a distance of a road edge from a vehicle's center point, and number of lanes.

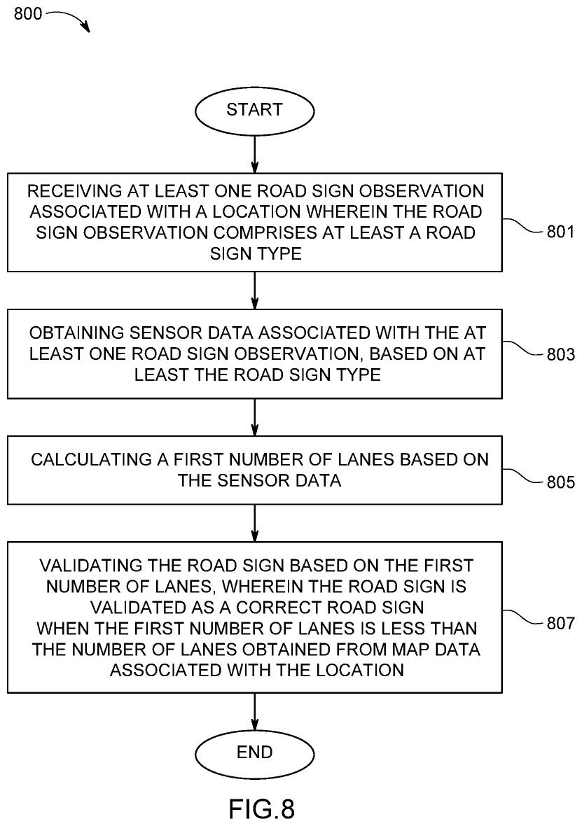

FIG. 8 illustrates a flow diagram of a method 800 for validating a road sign using sensor data, in accordance with an example embodiment. It will be understood that each block of the flow diagram of the method 800 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 800 illustrated by the flowchart diagram of FIG. 8 is validating road sign. Fewer, more, or different steps may be provided.

At step 801, the method 800 comprises receiving at least one road sign observation associated with a location wherein the road sign observation comprises at least a road sign type. The road sign type is a road narrows right, a road narrows left or a road narrows right and left. The system 101 may determine the vehicle location at the time of road sign observation by extracting the timestamp of the signRecognition message 201a1-1. Further, a match of the same timestamp is found in the positionEstimate message 201a2-1. The location of the road sign observation is determined by applying the positionOffsets 201a1-3 in the signRecognition message 201a1-1 to the vehicle's location.

At step 803, the method 800 comprises obtaining sensor data associated with the at least one road sign observation, based on at least the road sign type. In accordance with an embodiment, the sensor data may refer to the data captured by the vehicle sensors. The sensor data may include road boundary data which comprises one or more of a position offset data, a lateral offset data, longitudinal offset data, and a timestamp data. At step 807, the method 800 comprises calculating a first number of lanes based on the sensor data.

At step 807, the method 800 comprises validating the road sign based on the first number of lanes, wherein the road sign is validated as a correct road sign when the first number of lanes is less than the number of lanes obtained from map data associated with the location. The system 101 may update the map data based on the correct road sign.

In this manner, the method 800 may be configured to enable navigation of vehicles in a real-time and a reliable manner. The method 800 may be implemented using corresponding circuitry. For example, the method 800 may be implemented by an apparatus or system comprising a processor, a memory, and a communication interface of the kind discussed in conjunction with FIG. 2.

In some example embodiments, a computer programmable product may be provided. The computer programmable product may comprise at least one non-transitory computer-readable storage medium having stored thereon computer-executable program code instructions that when executed by a computer, cause the computer to execute the method 800.

In an example embodiment, an apparatus for performing the method 800 of FIG. 8 above may comprise a processor (e.g., the processor 201) configured to perform some or each of the operations of the method 800. The processor may, for example, be configured to perform the operations (801-807) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (801-807) may comprise, for example, the processor 201 which may be implemented in the system 101 and/or a device or circuit for executing instructions or executing an algorithm for processing information as described above.

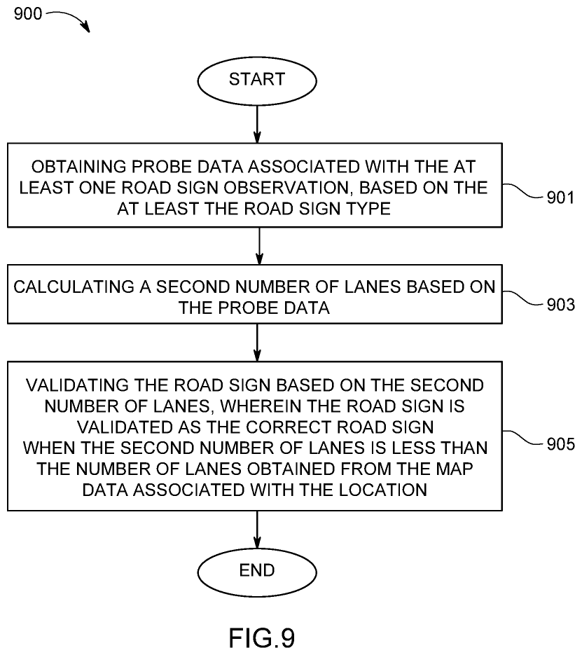

FIG. 9 illustrates a flow diagram of a method 900 for validating road sign using probe data, in accordance with an example embodiment. It will be understood that each block of the flow diagram of the method 900 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 900 illustrated by the flowchart diagram of FIG. 9 is validating road sign. Fewer, more, or different steps may be provided.

At step 901, the method 900 comprises obtaining probe data associated with the at least one road sign observation, based on the at least the road sign type. The road sign observation may be obtained in step 801 in FIG. 8. In one exemplary embodiment, the probe data may be collected by one or more devices in the vehicle such as one or more sensors. In an embodiment, the probe data may also be captured from connected-car sensors, smartphones, personal navigation devices, fixed road sensors, smart-enabled commercial vehicles, and expert monitors observing accidents and construction.

At step 903, the method 900 comprises ccalculating a second number of lanes based on the probe data. According to some example embodiments, the second number of lanes may be determined by aggregating a number of vehicles paths using probe data and by performing clustering operations. At step 905, the method 900 comprises validating the road sign based on the second number of lanes, wherein the road sign is validated as the correct road sign when the second number of lanes is less than the number of lanes obtained from the map data associated with the location. This is because the reduced number of lanes will indicate a natural narrowing of the road.

In this manner, the present disclosure provides efficient and user-friendly techniques for updating navigation instructions. Along with this, in some embodiments, most of the processing is done by a remote server based or cloud-based server, so the end user may be able to leverage fast processing and improved storage benefits provided by the present disclosure. Thus, the navigation instructions may be generated based on up-to-date and real time data, providing accurate and reliable navigation services to the end users.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A method for validating a road sign, the method comprising:
receiving at least one road sign observation associated with a location wherein the road sign observation comprises at least a road sign type;
obtaining sensor data associated with the at least one road sign observation, based on at least the road sign type;
calculating a first number of lanes based on the sensor data; and
validating the road sign based on the first number of lanes, wherein the road sign is validated as a correct road sign when the first number of lanes is less than the number of lanes obtained from map data associated with the location.

2. The method of claim 1, further comprises validating that the road sign is a false positive road sign when the calculated number of lanes is equal to the number of lanes obtained from the map data associated with the location.

3. The method of claim 1, wherein the calculating the number of lanes using sensor data further comprises using road boundary data, wherein the road boundary data comprises one or more of: a position offset data, a lateral offset data, longitudinal offset data, and a timestamp data.

4. The method of claim 1, wherein the road sign type comprises at least a road narrows sign wherein the road narrows sign comprises at least one of: a road narrows right, a road narrows left or a road narrows right and left.

5. The method of claim 4, wherein the road narrows sign further comprises at least of a road works.

6. The method of claim 1, wherein the road sign observation further comprises at least a background colour, the background colour further comprising at least one of a colour indicating a temporary change in the first number of lanes.

7. The method of claim 1, wherein the obtaining sensor data further comprises obtaining the sensor data after a configurable distance.

8. The method of claim 1, further comprising:
obtaining probe data associated with the at least one road sign observation, based on the at least the road sign type;
calculating a second number of lanes based on the probe data; and
validating the road sign based on the second number of lanes, wherein the road sign is validated as the correct road sign when the second number of lanes is less than the number of lanes obtained from the map data associated with the location.

9. The method of claim 8, further comprising validating that the road sign is the correct road based on the first number of lanes and second number of lanes.

10. A system for validating a road sign comprising, the system comprising:
at least one non-transitory memory configured to store computer executable instructions; and
at least one processor configured to execute the computer executable instructions to:
receiving at least one road sign observation associated with a location wherein the road sign observation comprises at least a road sign type;
obtaining sensor data associated with the at least one road sign observation, based on at least the road sign type;
calculating a first number of lanes based on the sensor data; and
validating the road sign based on the first number of lanes, wherein the road sign is validated as a correct road sign when the first number of lanes is less than the number of lanes obtained from map data associated with the location.

11. The system of claim 10, further comprises validating that the road sign is a false positive road sign when the calculated number of lanes is equal to the number of lanes obtained from the map data associated with the location.

12. The system of claim 10, wherein the calculating the number of lanes using sensor data further comprises using road boundary data, wherein the road boundary data comprises one or more of: a position offset data, a lateral offset data, longitudinal offset data, a timestamp data, and a road boundary type data.

13. The system of claim 10, wherein the road sign type comprises at least a road narrows sign wherein the road narrows sign comprises at least one of: a road narrows right, a road narrows left or a road narrows right and left.

14. The system of claim 13, wherein the road narrows sign further comprises at least of a road works.

15. The system of claim 10, wherein the road sign observation further comprises at least a background colour, the background colour further comprising at least one of a colour indicating a temporary change in the first number of lanes.

16. The system of claim 10, wherein the obtaining sensor data further comprises obtaining the sensor data after a configurable distance.

17. The system of claim 10, wherein obtaining probe data associated with the at least one road sign observation, based on the at least the road sign type;
calculating a second number of lanes based on the probe data; and
validating the road sign based on the second number of lanes, wherein the road sign is validated as the correct road sign when the second number of lanes is less than the number of lanes obtained from the map data associated with the location.

18. The system of claim 17, further comprising validating that the road sign is the correct road based on the first number of lanes and second number of lanes.

19. A computer programmable product comprising a non-transitory computer readable medium having stored thereon computer executable instruction which when executed by one or more processors, cause the one or more processors to conduct operations for validating a road sign, the operations comprising:
receiving at least one road sign observation associated with a location wherein the road sign observation comprises at least a road sign type;
obtaining sensor data associated with the at least one road sign observation, based on at least the road sign type;
calculating a first number of lanes based on the sensor data; and
validating the road sign based on the first number of lanes, wherein the road sign is validated as a correct road sign when the first number of lanes is less than the number of lanes obtained from map data associated with the location.

20. The computer programmable product of claim 19, wherein the operations further comprise validating that the road sign is a false positive road sign when the calculated number of lanes is equal to the number of lanes obtained from the map data associated with the location.
